(19) United States
(12) Patent Application Publication
(10) Pub. No.: US 2026/0145453 A1
(43) Pub. Date: May 28, 2026

(54) DUCT DEVICE, AIRFLOW GENERATION DEVICE, AND RECORDING APPARATUS

(71) Applicant: SEIKO EPSON CORPORATION, Tokyo (JP)

(72) Inventor: Yohei SAKAI, MATSUMOTO-SHI (JP)

(21) Appl. No.: 19/396,679

(22) Filed: Nov. 21, 2025

(30) Foreign Application Priority Data
Nov. 25, 2024 (JP) 2024-204489

(51) Int. Cl. B41J 29/377; B41J 29/02; B41J 29/13; B41J 29/393

(52) U.S. Cl. CPC B41J 29/377; B41J 29/02; B41J 29/13; B41J 29/393

(57) ABSTRACT

According to an aspect of the present disclosure, there is provided a duct device on which a air blower including a fan is mounted and in which gas is circulated by the fan, the duct device including a first mounting section on which the air blower is mounted to face the first mounting section in a first direction and a supporting part to which the air blower is fixed by a fixing part. The fixing part fixes the air blower and the supporting part in a second direction intersecting the first direction.

The present application is based on, and claims priority from JP Application Serial Number 2024-204489, filed Nov. 25, 2024, the disclosure of which is hereby incorporated by reference herein in its entirety.

### BACKGROUND

### 1. Technical Field

The present disclosure relates to a duct device, an airflow generation device, and a recording apparatus.

### 2. Related Art

Various duct devices in which gas is circulated in ducts by fans have been used. Among the duct devices, there is a duct device in which a fan is fixed to a duct by a fixing member such as a screw. For example, JP-A-2007-148102 discloses an image forming apparatus including a duct to which a fan is fixed by a screw.

JP-A-2007-148102 is an example of the related art.

In the duct device in which the fan is fixed to the duct by the fixing member such as the screw, the fan is sometimes cleaned or replaced. For this reason, the fan is configured to be detachable from the duct. Thus, for example, JP-A-2007-148102 discloses that, when the fan is attached to an opening of the duct, the screw is inserted in parallel to an attachment direction of the fan to screw the fan. In other words, the attachment direction of the fan and a screwing direction are the same direction. However, in the duct device of the related art in which the fan is fixed to the duct by the fixing member such as the screw like the image forming apparatus disclosed in JP-A-2007-148102, it is difficult to attach and detach the fan to and from the duct unless there is a space for removing the screw in the attachment direction of the fan. That is, in order to facilitate attachment and detachment of the fan, the size of the apparatus has been increased.

### SUMMARY

According to an aspect of the present disclosure, there is provided a duct device on which a air blower including a fan is mounted and in which gas is circulated by the fan, the duct device including: a first mounting section on which the air blower is mounted to face the first mounting section in a first direction; and a fixing section to which the air blower is fixed by a fixing member, wherein the fixing member fixes the air blower and the fixing section in a second direction intersecting the first direction.

### BRIEF DESCRIPTION OF THE DRAWINGS

FIG. 1 is a perspective view of a recording apparatus including a duct device (an airflow generation device) in an embodiment of the present disclosure.

FIG. 2 is a schematic diagram viewed from the front side illustrating a medium conveyance path of the recording apparatus in FIG. 1.

FIG. 3 is a cross-sectional view viewed from the back side illustrating an internal configuration of the recording apparatus in FIG. 1.

FIG. 4 is a partially enlarged diagram of the recording apparatus in FIG. 3 and is a diagram illustrating the periphery of a mist collection section serving as the airflow generation device.

FIG. 5 is a diagram illustrating a state halfway in detaching a air blower from a state in FIG. 4.

FIG. 6 is a perspective view illustrating the mist collection section serving as the airflow generation device of the recording apparatus in FIG. 1.

FIG. 7 is a perspective view illustrating the air blower of the mist collection section in FIG. 6.

FIG. 8 is a perspective view illustrating the periphery of a restricting section that restricts movement of the air blower in the mist collection section in FIG. 6 in the up-down direction with respect to an attachment portion of the air blower.

FIG. 9 is a perspective cross-sectional view illustrating the periphery of the restricting section that restricts movement of the air blower in the mist collection section in FIG. 6 in the up-down direction with respect to the attachment portion of the air blower.

FIG. 10 is a perspective view illustrating the air blower in the mist collection section and the attachment portion of the air blower in FIG. 6.

FIG. 11 is a partially enlarged diagram of FIG. 10 and is a perspective view illustrating the periphery of limiting sections that limit movement of the air blower in the mist collection section in FIG. 6 in the up-down direction with respect to the attachment portion of the air blower.

FIG. 12 is a cross-sectional view viewed from the back side illustrating the internal configuration of the recording apparatus in FIG. 1 from which some of constituent members are detached and is a diagram illustrating the periphery of a head drive substrate.

FIG. 13 is a perspective cross-sectional view illustrating the internal configuration of the recording apparatus in FIG. 1 from which some of the constituent members are detached and is a diagram illustrating the periphery of the head drive substrate.

### DESCRIPTION OF EMBODIMENTS

The present disclosure is schematically explained below.

A duct device according to a first aspect of the present disclosure is a duct device on which a air blower including a fan is mounted and in which gas is circulated by the fan, the duct device including: a first mounting section on which the air blower is mounted to face the first mounting section in a first direction; and a fixing section to which the air blower is fixed by a fixing member, wherein the fixing member fixes the air blower and the fixing section in a second direction intersecting the first direction.

According to this aspect, the duct device includes the first mounting section on which the air blower is mounted to face the first mounting section in the first direction and the fixing section to which the air blower is fixed by the fixing member, and the fixing member fixes the air blower and the fixing section in the second direction intersecting the first direction. That is, the mounting direction of the air blower and the fixing direction of the air blower are intersecting directions. For this reason, even when there is no space in the first direction, it is possible to access the fan in the second direction and attach and detach the fan to and from a duct. Therefore, it is possible to easily attach and detach the fan while suppressing an increase in the size of the device.

In a duct device according to a second aspect of the present disclosure, in an aspect dependent from the first aspect, the fixing section may be located further downstream than a center of the fan in an insertion direction of the fixing member in the second direction.

According to this aspect, the fixing section is located further downstream than the center of the fan in the insertion direction of the fixing member. With such a configuration, it is possible to secure a space equal to or larger than the half length of the air blower as a space for accessing the fan.

In a duct device according to a third aspect of the present disclosure, in an aspect dependent from the second aspect, the fixing section may be located further downstream than the fan in the insertion direction.

According to this aspect, the fixing section is located further downstream than the fan in the insertion direction of the fixing member. With such a configuration, it is possible to secure a space equal to or larger than the length of the fan as the space for accessing the fan.

In a duct device according to a fourth aspect of the present disclosure, in an aspect dependent from any one of the first to third aspects, in the first direction, the fixing section may be located in a range in which the fan is disposed.

According to this aspect, in the first direction, the fixing section is located in the range in which the fan is disposed. With such a configuration, it is possible to reduce a space of the device in the first direction and reduce the size of the device in a direction intersecting the first direction.

In a duct device according to a fifth aspect of the present disclosure, in an aspect dependent from any one of the first to fourth aspects, the air blower may include the fan and an attachment section attached to the fixing section, the attachment section may include a fixed section fixed to the fixing section, and the fixing section and the fixed section may extend in the first direction.

According to this aspect, the air blower includes the fan and the attachment section attached to the fixing section, the attachment section includes the fixed section fixed to the fixing section, and the fixing section and the fixed section extend in the first direction. With such a configuration, it is possible to insert the fixing section in the second direction and fix the fixing section to the fixed section.

In a duct device according to a sixth aspect of the present disclosure, in an aspect dependent from the fifth aspect, the fixed section may be formed of metal, and the fixing member may be screwed into the fixed section.

According to this aspect, the fixed section is formed of metal and the fixing member is screwed into the fixed section. With such a configuration, it is possible to make the fixed section robust with the metal and reuse the fixed section. For this reason, when the air blower is replaced, since the fixed section is reused and only the fan has to be replaced, it is possible to reduce an environmental load.

In a duct device according to a seventh aspect of the present disclosure, in an aspect dependent from the fifth or sixth aspect, the fixing section may include a limiting section configured to limit movement of the fixed section in the first direction.

According to this aspect, the fixing section includes the limiting section configured to limit the movement of the fixed section in the first direction. With such a configuration, it is possible to improve positional accuracy in the first direction, for example, suppress rattling of the air blower.

In a duct device according to an eighth aspect of the present disclosure, in an aspect dependent from any one of the first to seventh aspects, the air blower may include the fan and an attachment section attached to the fixing section, and the first mounting section may include a restricting section configured to restrict movement of the attachment section in the first direction.

According to this aspect, the air blower includes the fan and the attachment section attached to the fixing section, and the first mounting section includes the restricting section configured to restrict movement of the attachment section in the first direction. It is likely that, if a direction of fixing by the fixing section is not the first direction, the positional accuracy in the first direction is deteriorated. However, with the configuration explained above, it is possible to improve the positional accuracy in the first direction, for example, suppress rattling of the air blower with the restricting section.

In a duct device according to a ninth aspect of the present disclosure, in an aspect dependent from the eighth aspect, the attachment section may include a restricted section restricted from moving in the first direction by the restricting section, and the restricted section may be capable of, by sliding the air blower in a direction intersecting the first direction, switching a state of being engaged with the restricting section and a state of being not engaged with the restricting section.

According to this aspect, the attachment section includes the restricted section restricted from moving in the first direction by the restricting section, and the restricted section is capable of, by sliding the air blower in the direction intersecting the first direction, switching the state of being engaged with the restricting section and the state of being not engaged with the restricting section. With such a configuration, it is possible to easily implement engagement of the restricting section and the restricted section.

In a duct device according to a tenth aspect of the present disclosure, in an aspect dependent from any one of the first to ninth aspects, the duct device may further include a second mounting section on which a capturing section configured to capture foreign matters can be mounted, and the capturing section may be mounted on the second mounting section in the second direction.

According to this aspect, the duct device includes the second mounting section on which the capturing section that captures foreign matters can be mounted, and the capturing section is mounted on the second mounting section in the second direction. With such a configuration, it is possible to capture foreign matters in the duct. Since both of a replacement direction of the capturing section and an access direction to the fixing member are the second direction and can be the same direction, it is possible to perform maintenance of the device in one direction and it is possible to reduce a space necessary for the maintenance.

An airflow generation device according to an eleventh aspect of the present disclosure includes: the duct device according to any one of the first to tenth aspects; and the air blower.

According to this aspect, it is possible to provide the airflow generation device that can facilitate attachment and detachment of the fan while suppressing an increase in the size of the device.

In an airflow generation device according to a twelfth aspect of the present disclosure, in an aspect dependent from the eleventh aspect, the airflow generation device may further include a frame to which the duct device is attached, and the duct device may be attached to the frame in the second direction.

According to this aspect, the airflow generation device includes the frame to which the duct device is attached, and the duct device is attached to the frame in the second direction. With such a configuration, since both of the attachment direction of the duct device and the access direction to the fixing member are the second direction and can be the same direction, it is possible to easily perform maintenance of the device in one direction and it is possible to reduce a space necessary for the maintenance.

In an airflow generation device according to a thirteenth aspect of the present disclosure, in an aspect dependent from the eleventh or twelfth aspect, the airflow generation device may further include a housing in which the duct device is housed, and the housing may be opened upstream in an insertion direction of the fixing member in the second direction.

According to this aspect, the airflow generation device includes the housing in which the duct device is housed, and the housing is opened upstream in the insertion direction of the fixing member in the second direction. With such a configuration, an opening provided in the housing is on the upstream side in the insertion direction of the fixing member, and the fixing member and the fan can be easily attached and detached through the opening.

A recording apparatus according to a fourteenth aspect of the present disclosure includes: a recording section configured to perform recording on a medium; and the airflow generation device according to any one of the eleventh to thirteenth aspects.

According to this aspect, it is possible to provide the recording apparatus that can facilitate attachment and detachment of the fan while suppressing an increase in the size of the apparatus.

In a recording apparatus according to a fifteenth aspect of the present disclosure, in an aspect dependent from the fourteenth aspect, the recording apparatus may further include a control section configured to control the recording section, a distance between the control section and the airflow generation device in the first direction may be smaller than a distance between an end portion of the duct device and the fixing section in an insertion direction of the fixing member in the second direction.

According to this aspect, the recording apparatus includes the control section configured to control the recording section, and the distance between the control section and the airflow generation device in the first direction is smaller than the distance between the end portion of the duct device and the fixing section in the insertion direction of the fixing member in the second direction. With such a configuration, even if the control section is configured to block access to the fixing member in the first direction, since the fixing member can be accessed in the second direction, it is possible to easily perform maintenance.

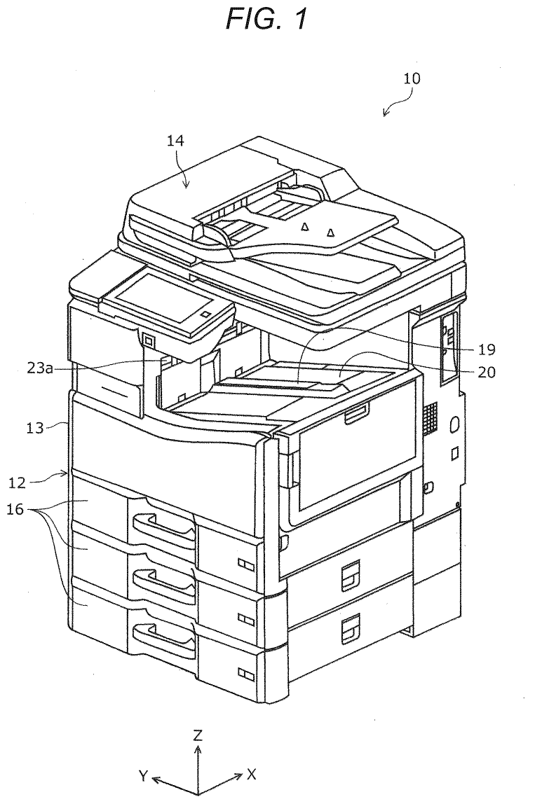

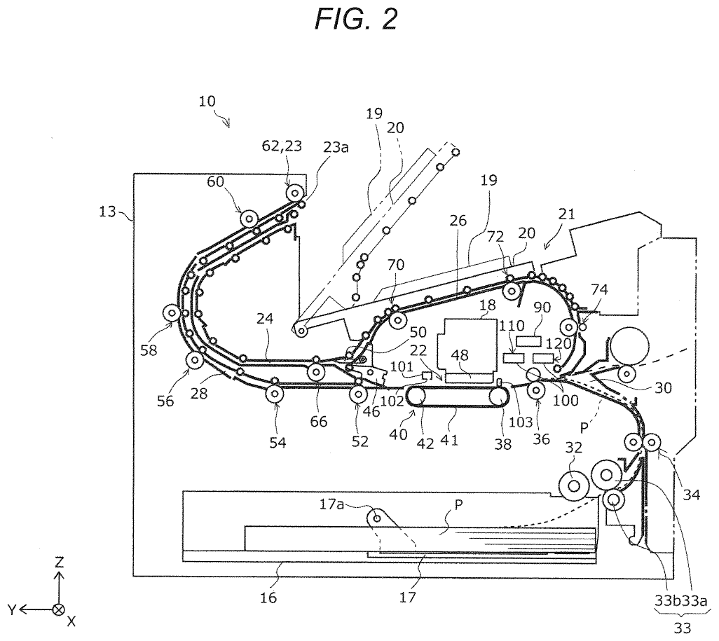

The present disclosure is specifically explained below. First, an overview of a recording apparatus according to an embodiment of the present disclosure is explained with reference to FIGS. 1 and 2. An inkjet printer 10 (hereinafter sometimes simply referred to as printer 10) is explained as an example of the recording apparatus in the present embodiment. In an X-Y-Z coordinate system illustrated in the figures, an X-axis direction indicates the width direction of a medium P in a conveyance path in the recording apparatus, a Y-axis direction indicates the length direction of the medium P on which recording is performed by a recording section explained below, and a Z-axis direction indicates the apparatus height direction. The Y-axis direction is the apparatus width direction.

The printer 10 is configured as a multifunction peripheral including an apparatus main body 12 and a scanner unit 14. The apparatus main body 12 includes a plurality of medium storage cassettes 16 that store media P. The medium storage cassettes 16 are attached to be detachably attachable from a −X-axis direction side, which is the front side of the apparatus main body 12. In the present specification, the medium P indicates, for example, paper such as plain paper, thick paper, or photographic paper.

In the apparatus height direction in the apparatus main body 12, recording is executed in a recording section 18 between the scanner unit 14 and the medium storage cassettes 16. After the recording, the medium P is discharged from an outlet 23a of a discharge section 23. A medium placing section 20 that receives the medium P discharged from the outlet 23a is provided. The medium placing section 20 includes ribs 19 extending in the conveyance direction at the center of a placement surface in the width direction (the X-axis direction) intersecting the conveyance direction of the medium P discharged from the discharge section 23 (a −Y direction).

The printer 10 in the present embodiment includes a medium conveyance path 21 on the inside of the housing 13. The medium conveyance path 21 includes a straight path 22, a face-down discharge path 28, and a feeding path 30 connected from the medium storage cassette 16 to the straight path 22. Further, the medium conveyance path 21 includes a switchback path 24 and a reversal path 26 and is configured to be capable of performing so-called double-sided recording for executing recording on a second surface after recording on a first surface in the medium P.

In the feeding path 30, a feeding roller 32, a separation roller pair 33, and a conveyance roller pair 34 are provided in order in the conveyance direction of the medium P. The feeding roller 32 is driven to rotate by a not-illustrated driving source. The separation roller pair 33 separates the media P by nipping the media P between a driving roller 33a and a driven roller 33b.

The conveyance roller pair 34 includes a driving roller and a driven roller. The driving roller is controlled by, via a not-illustrated driving source, a control section 90 provided in the apparatus main body 12. A line head 48 explained below is also controlled by the control section 90. That is, the control section 90 is configured to be capable of executing control necessary for a recording operation in the printer 10.

In the following explanation, it is assumed that, in conveyance roller pairs appearing in the present specification, one roller is configured as a driven roller and the other roller is configured as a driving roller driven to rotate by a not-illustrated driving source. In the present embodiment, unless particularly explained otherwise, one roller is configured as a spur including a plurality of teeth on the outer periphery and the driving roller, which is the other roller, is configured as, for example, a rubber roller.

The media P stored in the medium storage cassette 16 are supported on a hopper 17 provided in the medium storage cassette 16. The hopper 17 turns with, as a fulcrum, a turning shaft 17a provided in the hopper 17 and lifts the media P upward. At that time, the feeding roller 32 comes into contact with the uppermost medium P among the media P supported by the hopper 17 and conveys the medium P to the downstream side in the conveyance direction. At this time, the next and subsequent media P are sometimes conveyed together with the uppermost medium P. However, the uppermost medium P and the next and subsequent media P are separated by the separation roller pair 33 and only the uppermost medium P is conveyed to the downstream side in the conveyance direction.

A conveyance roller pair 36 is provided on the downstream side in the conveyance direction of the conveyance roller pair 34. In the present embodiment, the feeding path 30 and the straight path 22 are connected at the position of the conveyance roller pair 36. That is, the feeding path 30 is set as a path from the medium storage cassette 16 to the conveyance roller pair 36.

The straight path 22 is configured as a linearly extending path. The conveyance roller pair 36, a conveyance mechanism 40 including a driving roller 38, a driven roller 42, and an endless belt 41, the recording section 18, and a first flap 46 are provided in the straight path 22 in order in the conveyance direction. In the present embodiment, the straight path 22 is set as a path from the conveyance roller pair 36 to the first flap 46. The endless belt 41 is charged by not-illustrated voltage applying means. The endless belt 41 attracts the medium P with static electricity charged by the voltage applying means and conveys the attracted medium P in a conveyance direction Y while causing the medium P to face the recording section 18. At this time, charges on a printing surface of the medium P are removed by a static eliminator brush 103, whereby a decrease in an electrostatic attraction force for the medium P by the endless belt 41 is suppressed.

The recording section 18 includes the line head 48. The conveyance mechanism 40 is provided below the line head 48. In the present embodiment, the line head 48 is configured to eject ink to the recording surface of the medium P to execute recording when the medium P is conveyed to a position facing the line head 48 on the conveyance mechanism 40. The line head 48 is a recording head in which nozzles that eject the ink are provided to cover the entire width of the medium P and is configured as a recording head capable of performing recording on the entire width of the medium without involving movement in the medium width direction. The printer 10 in the present embodiment includes the line head 48 but may include a serial type recording head that is mounted on a carriage and ejects liquid to a medium to perform recording while reciprocating in a direction intersecting the medium conveyance direction.

In the recording section 18, that is, the medium conveyance path 21 on the downstream side of the line head 48, suction ports 102 of a duct 101, which is a part of a mist collection section 110, are provided on the side facing the recording surface of the medium P. On the rear surface (the surface in the +X direction) of the apparatus main body 12, the mist collection section 110 that includes a air blower 100 and collects ink mist generated when ink is ejected from the line head 48 is provided. At a position aligned with the mist collection section 110 in the Y axis direction, a paper dust collection section 120 that includes the air blower 100 and collects foreign matters such as paper dust adhering to the static eliminator brush 103 from the medium P is provided. FIG. 2 schematically illustrates the mist collection section 110 and the paper dust collection section 120 based on the position of the air blower 100. Here, both of the mist collection section 110 and the paper dust collection section 120 are airflow generation devices on which the air blowers 100 including fans 100a explained below are mounted and in which gas is circulated in ducts 101 explained below by the fans 100a. Portions of the mist collection section 110 and the paper dust collection section 120 on which the air blowers 100 are mounted can be regarded as duct devices including the ducts 101. That is, the air blowers 100 and the portions on which the air blowers 100 serving as the duct devices are mounted can be regarded as the mist collection section 110 and the paper dust collection section 120 serving as the airflow generation devices.

The conveyance mechanism 40 including the driving roller 38, the driven roller 42, and the endless belt 41 is provided at a position facing the line head 48. The first flap 46 is located on the downstream side in the conveyance direction of the conveyance mechanism 40. The first flap 46 is configured to be switchable by a not-illustrated driving mechanism to connect the straight path 22 and the switchback path 24 or connect the straight path 22 and the face-down discharge path 28.

A second flap 50 is provided above the first flap 46 in the apparatus height direction (the Z-axis direction). The second flap 50 is driven by a not-illustrated interlocking mechanism in association with the operation of the first flap 46. The first flap 46 and the second flap 50 change postures thereof according to control of the control section 90.

The face-down discharge path 28 is curved and reversed while extending to the upper side from the straight path 22 in the apparatus height direction. The face-down discharge path 28 includes a conveyance roller pair 52, a conveyance roller pair 54, a conveyance roller pair 56, a conveyance roller pair 58, a conveyance roller pair 60, and a conveyance roller pair 62 configuring the discharge section 23. The face-down discharge path 28 has a path from the first flap 46 to the outlet 23a located on the downstream side in the conveyance direction of the conveyance roller pair 62. That is, the face-down discharge path 28 is the medium conveyance path 21 connected to the straight path 22 and is a path that reverses the recording surface of the medium P between the recording section 18 and the discharge section 23 and sends the medium P having passed through the recording section 18 to the discharge section 23.

The medium P, on the recording surface of which recording is executed in the recording section 18, is sequentially nipped by the conveyance roller pair 52, the conveyance roller pair 54, the conveyance roller pair 56, the conveyance roller pair 58, the conveyance roller pair 60, and the conveyance roller pair 62 in order in the conveyance direction from the first flap 46 in the face-down discharge path 28 and is conveyed through the face-down discharge path 28. Then, the medium P is discharged from the outlet 23a toward the medium placing section 20.

The reversal path 26 is a path for reversing the medium P and includes a conveyance roller pair 70, a conveyance roller pair 72, and a conveyance roller pair 74. The medium P once having passed through the straight path 22, which that is the medium conveyance path 21 facing the recording section 18, passes through the reversal path 26, whereby the surface of the medium P facing the recording section 18 is reversed and the medium P passes through the straight path 22, which is the medium conveyance path 21 facing the recording section 18, again. When the medium P passes through the reversal path 26, recording can be performed on both the surfaces of the medium P.

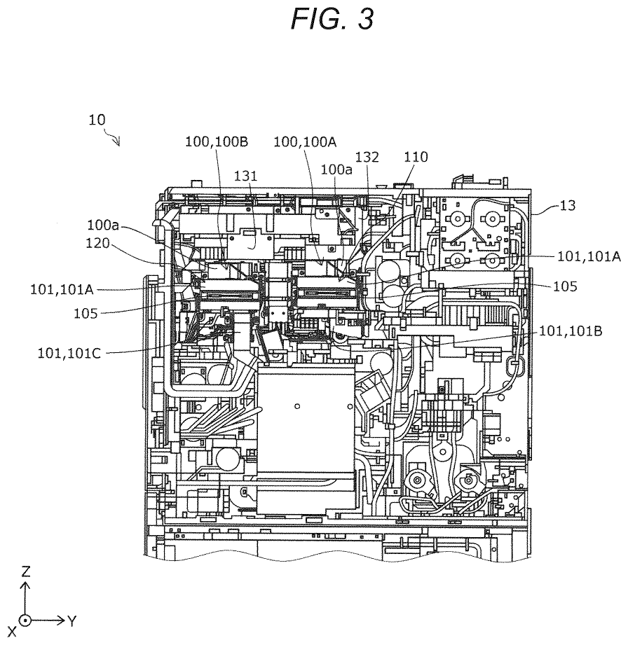

Here, the mist collection section 110 configuring the airflow generation device and the duct device is explained with reference to FIG. 3 as well. As illustrated in FIG. 3, a air blower 100A and the ducts 101 (a duct 101A and a duct 101B) are provided in the mist collection section 110. Further, as illustrated in FIG. 2, a plurality of suction ports 102 are provided in a portion extending in the X-axis direction in the duct 101B of the ducts 101. Specifically, the suction ports 102 are provided to correspond to an entire region of ink ejection by the line head 48 in the X-axis direction. That is, the suction ports 102 are provided over the medium width direction.

The duct 101 is provided in the mist collection section 110 and filters 105 that purify air containing mist collected from the suction ports 102 are provided in the duct 101. The duct 101B of the mist collection section 110 extends from an attachment portion of the air blower 100 further to the downstream side in the conveyance direction of the medium P than the line head 48. The suction ports 102 are provided at a position further on the downstream side in the conveyance direction of the medium P than the line head 48. The filters 105 in the present embodiment absorb mist in collected air sent from the suction ports 102 and may be further combined with, for example, a filter containing activated carbon to adsorb volatile organic compounds contained in ink.

Subsequently, the paper dust collection section 120 configuring the airflow generation device and the duct device is explained with reference to FIG. 3. As illustrated in FIG. 2, in the paper dust collection section 120, the static eliminator brush 103 and a not-illustrated scraping member are provided, the static eliminator brush 103 being provided in an endless belt-shaped substrate section rotatable with the conveyance direction as a rotation axis and extended in the X-axis direction by being stretched between not-illustrated two pulleys. When the static eliminator brush 103 is brought into contact with the medium P conveyed by the endless belt 41, foreign matters such as paper dust and ink adhering to the medium P adhere to the static eliminator brush 103.

The scraping member comes into contact with the static eliminator brush 103 to scrape off or adsorb paper dust adhering to the static eliminator brush 103 to remove the paper dust from the static eliminator brush 103. As illustrated in FIG. 3, in the paper dust collection section 120, a air blower 100B and the ducts 101 (the duct 101A and a duct 101C) are provided. The foreign matters such as the paper dust scraped out by the scraping member are sucked via a not-illustrated duct port provided in the duct 101C illustrated in FIG. 3 of the ducts 101 (the duct 101A and the duct 101C) configuring the paper dust collection section 120. The duct 101C of the paper dust collection section 120 extends from the duct 101A, to which the air blower 100 is attached, to the vicinity of the static eliminator brush 103. The duct port is provided near the static eliminator brush 103 and the scraping member. The duct 101 is provided in the paper dust collection section 120. In the duct 101, the filters 105 that purify air containing foreign matters such as paper dust collected from the not-illustrated duct port are provided. The filters 105 in the present embodiment capture foreign matters in the collected air sent from the not-illustrated duct port.

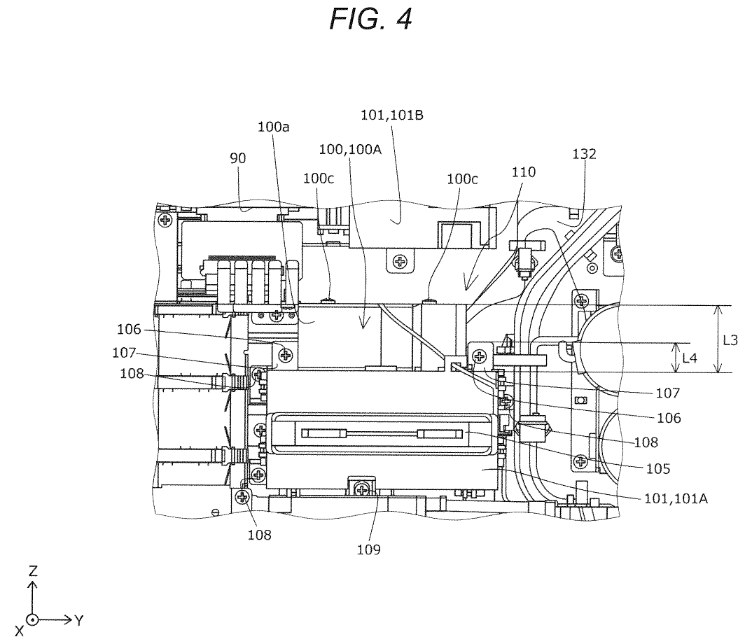

Here, the mist collection section 110 configuring the airflow generation device and the duct device and the paper dust collection section 120 configuring the airflow generation device and the duct device have the same configuration of the attachment portions of the air blower 100 and the air blower 100. Thus, hereinafter, details of a configuration of the attachment portions of the air blower 100 and the air blower 100 configuring the mist collection section 110 and the paper dust collection section 120 configuring the airflow generation device and the duct device are explained with reference to FIGS. 3 to 12. Although FIGS. 4 to 11 illustrate the air blower 100A of the mist collection section 110 and the attachment portion thereof, since the air blower 100B of the paper dust collection section 120 and the attachment portion thereof have the same configuration, the following explanation can be regarded as explanation of the air blower 100 of the paper dust collection section 120 and the attachment portion thereof by replacing the mist collection section 110 with the paper dust collection section 120.

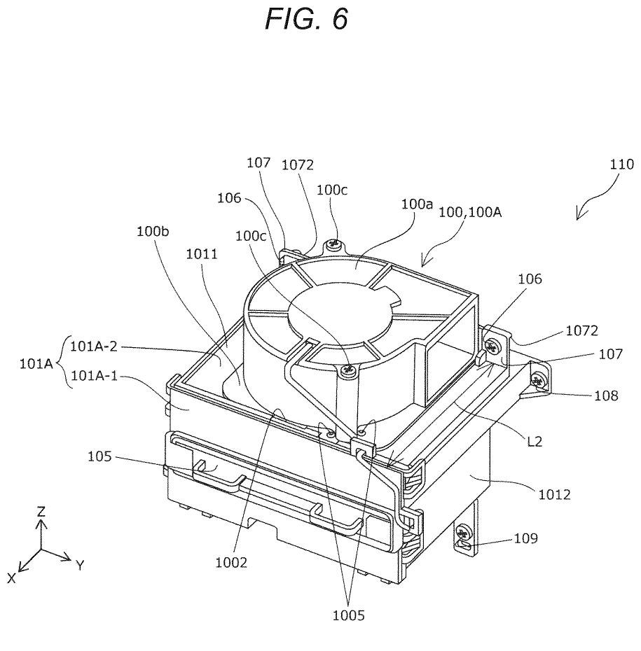

As explained above, the mist collection section 110 in the present embodiment is mounted with the air blower 100 including the fan 100a and configures a duct device in which gas is circulated by the fan 100a. As illustrated in FIG. 4, FIG. 6, and the like, the mist collection section 110 includes an upper surface portion 1011 of the duct 101A serving as a first mounting section on which the air blower 100 is mounted to face the first mounting section in the up-down direction serving as the first direction (the Z-axis direction) and fixing sections 107 to which the air blower 100 is fixed by metal screws 106, which are fixing members. Here, the metal screws 106 fix the air blower 100 and the fixing sections 107 in the second direction (the X-axis direction) intersecting the first direction. The duct 101A in the present embodiment includes a first portion 101A-1 made of plastic provided on the +X direction side and a second portion 101A-2 made of plastic to which the first portion 101A-1 is attached. The air blower 100 is mounted on the surface on the +Z direction side of the second portion 101A-2. At least a part of the duct 101A may be made of metal.

As explained above, in the mist collection section 110 in the present embodiment, the mounting direction of the air blower 100 (the Z-axis direction) and the fixing direction of the air blower 100 (the X-axis direction) are intersecting directions. For this reason, in the mist collection section 110 in the present embodiment, even when there is no space in the first direction (the Z-axis direction), it is possible to access the fan 100a in the second direction (the X-axis direction) and attach and detach the fan 100a to and from the duct 101 together with the air blower 100. Therefore, the mist collection section 110 in the present embodiment can facilitate attachment and detachment of the fan 100a while suppressing an increase in the size of the apparatus. With such a configuration, for example, a plate-shaped nut or the like may not be used and there is an advantage that the number of components can be reduced. Further, with such a configuration, a component for attaching a nut or the like to the duct 101 is unnecessary and there is an advantage that the configuration of the duct 101 can be simplified. In the present embodiment, the mounting direction of the air blower 100 (the Z-axis direction) and the fixing direction of the air blower 100 (the X-axis direction) are perpendicular directions but are not limited thereto.

Here, the fixing sections 107 are preferably located further downstream than the center of the fan 100a in the insertion direction of the metal screws 106 (−X direction) in the second direction (the X-axis direction). With such a configuration, it is possible to secure a space equal to or larger than the half length of the air blower 100 as a space for accessing the fan 100a (the air blower 100).

In the mist collection section 110 in the present embodiment, as illustrated in FIG. 6 and the like, such a configuration is not only satisfied and the fixing sections 107 are located further downstream than the fan 100a in the insertion direction of the metal screws 106 (the −X direction). In the mist collection section 110 in the present embodiment, with such a configuration, a space exceeding the half length of the air blower 100 and equal to or larger than the length of the fan 100a as a space for accessing the fan 100a can be secured.

As illustrated in FIG. 4, in the mist collection section 110 in the present embodiment, in the first direction (the Z-axis direction), the fixing sections 107 are located in a range L3 in which the fan 100a is disposed. As illustrated in FIG. 4, in the first direction (the Z-axis direction), a range L4 in which the fixing sections 107 are disposed overlaps the range L3 in which the fan 100a is disposed. With such a configuration, it is possible to reduce the space of the apparatus in the first direction (the Z-axis direction) and it is possible to reduce the size of the apparatus in the direction crossing the first direction. In the second direction (the X-axis direction), the range in which the fixing sections 107 are disposed may not overlap the range in which the fan 100a is disposed. However, it is possible to further reduce the size of the apparatus by overlapping the ranges.

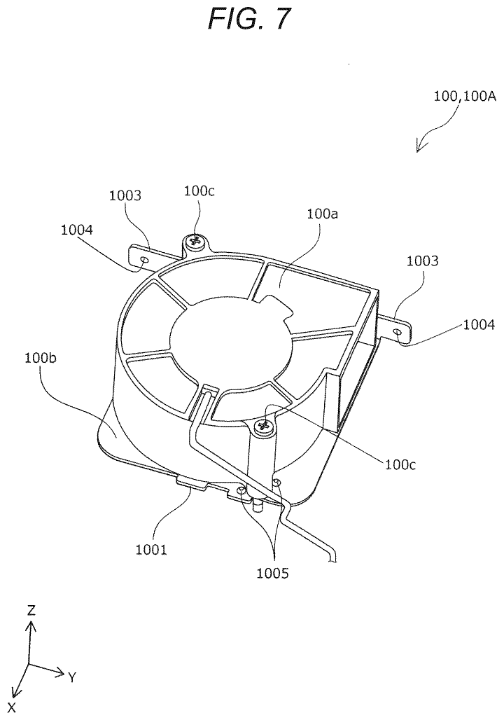

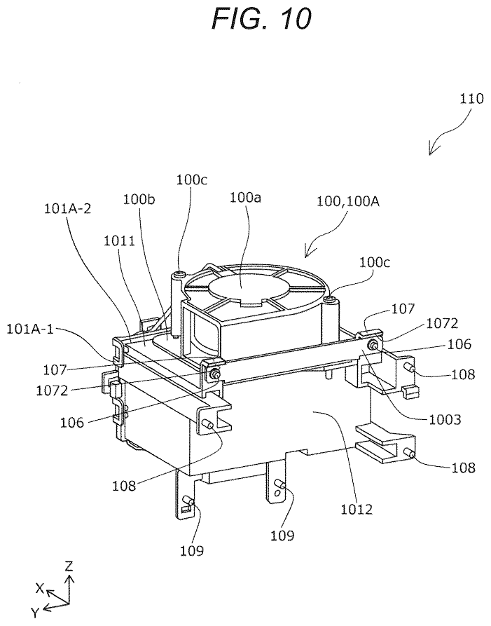

In the mist collection section 110 in the present embodiment, as illustrated in FIGS. 7, 10, and the like, the air blower 100 includes the fan 100a and a sheet metal 100b serving as an attachment section attached to the fixing sections 107. As illustrated in FIG. 7 and the like, the fan 100a and the sheet metal 100b are fixed by a metal screw 100c. Projections 1005 for positioning the fan 100a are provided in the sheet metal 100b. The sheet metal 100b includes fixed sections 1003 fixed to the fixing sections 107. Both of the fixing sections 107 and the fixed sections 1003 are formed by planes parallel to the first direction (the Z-axis direction). Since the fixing sections 107 and the fixed sections 1003 extend in the first direction (the Z-axis direction) as explained above, the fixing sections 107 can be inserted in the second direction (the X-axis direction) and fixed to the fixed sections 1003. The attachment section in the present embodiment is the sheet metal but may not be the sheet metal.

From another point of view, the fixed sections 1003 include screw holes 1004 and are formed of metal, and the metal screws 106 are screwed into the fixed sections 1003 in a state in which the fixing sections 107 including hole sections 1071, through which screws can be inserted, are sandwiched between the heads of the metal screws 106 and the fixed sections 1003. With such a configuration, it is possible to make the fixed sections 1003 robust with the metal and reuse the fixed sections 1003. For this reason, when the air blower 100 is replaced, since the fixed sections 1003 is reused and only the fan 100a has to be replaced, it is possible to reduce an environmental load. The hole sections 1071 in the present embodiment are round holes but may be, for example, U-shaped holes opened in the +Z direction. By forming the hole sections 1071 as the U-shaped hole, it is possible to attach and detach the fixing sections 107 and the fixed sections 1003 only by loosening the metal screws 106 without completely removing the metal screws 106.

When the screws serving as the fixing sections or the fixed sections 1003 are made of plastic and screwed, the members made of plastic cannot be reused. This is because a screwed portion of plastic is easily deformed. On the other hand, with the configuration in the present embodiment, a positional relationship in which the fixing sections 107 are sandwiched between the fixed sections 1003 and the heads of the metal screws 106 are substantially limited, and the air blower 100 is suitably positioned. In the present embodiment, since the entire attachment section is the sheet metal made of metal, the fan 100a can also be reused when being attached to the sheet metal. However, without being limited to such a configuration, a material other than metal may be used in a part of the attachment section.

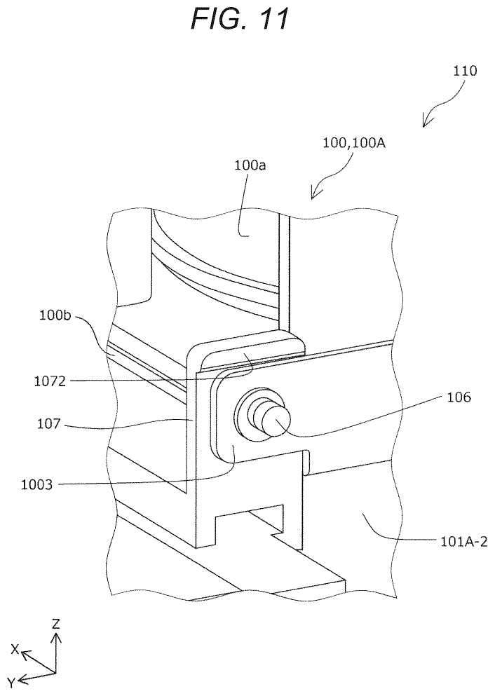

Here, in the mist collection section 110 in the present embodiment, as illustrated in FIG. 11 and the like, eaves sections 1072 facing the fixed sections 1003 from the +Z direction side when the air blower 100 is mounted at an appropriate position are provided in the fixing sections 107. In other words, the fixing sections 107 include the eaves sections 1072 serving as limiting sections that limit movement of the fixed sections 1003 in the first direction (the Z-axis direction). With such a configuration, the mist collection section 110 in the present embodiment can improve positional accuracy in the first direction (the Z-axis direction) for, for example, suppressing rattling of the air blower 100.

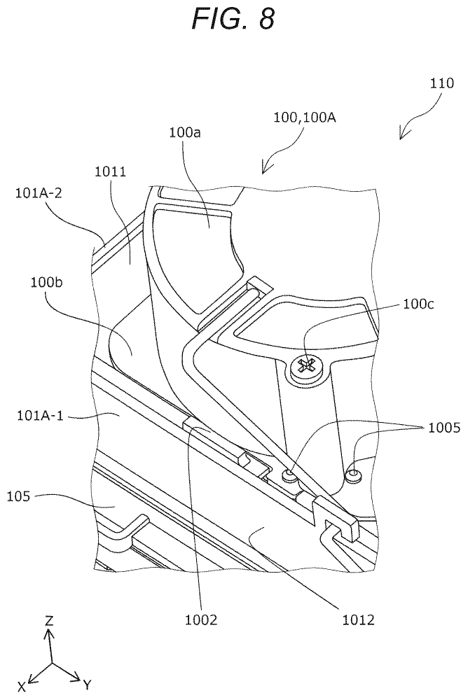

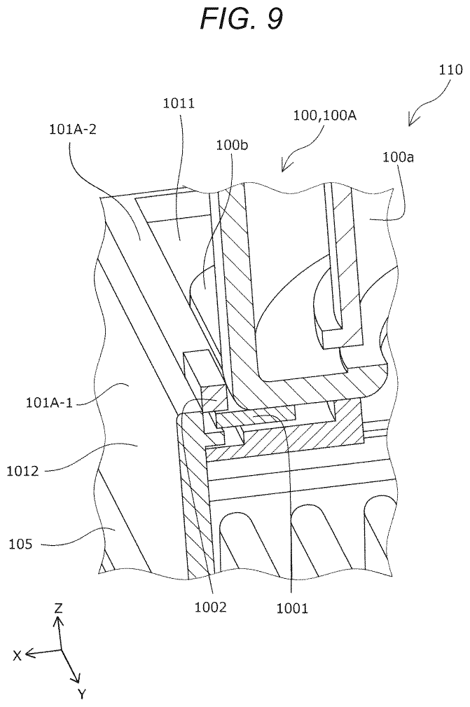

Further, in the mist collection section 110 in the present embodiment, as illustrated in FIG. 7 and the like, a protruding section 1001 protruding in the +X direction is provided on the sheet metal 100b. As illustrated in FIGS. 8, 9, and the like, an eaves section 1002 facing the protruding section 1001 from the +Z direction side when the air blower 100 is mounted at an appropriate position is provided in the second portion 101A-2 of the duct 101A on which the air blower 100 is mounted. In other words, the upper surface portion 1011 of the duct 101A serving as the first mounting section includes the eaves section 1002 serving as a restricting section that restricts movement of the sheet metal 100b in the first direction (the Z-axis direction).

Since the mist collection section 110 in the present embodiment has such a configuration, it is possible to improve the positional accuracy in the first direction (the Z-axis direction), for example, suppress rattling of the air blower 100 with the eaves section 1002. In particular, in the case of a configuration in which the position of the fixing sections 107 is at the end portion (the −X-direction side end portion) like the mist collection section 110 in the present embodiment, it is likely that rattling occurs at a portion (the +X-direction side end portion) away from the positions of the fixing sections 107. However, it is possible to suitably suppress the rattling even in such a configuration. With such a configuration, a plate-shaped nut is unnecessary and it is possible to reduce the number of components. In the present embodiment, since the eaves section 1002 serving as the restricting section restricts movement of the protruding section 1001 provided at the +X-direction side end portion of the sheet metal 100b, rattling is more effectively suppressed. However, the restricting section is not limited thereto. That is, the restricting section may be configured to restrict a portion other than the +X-direction side end portion of the attachment section.

Here, a replacement operation for the air blower 100 is explained. FIG. 4 illustrates a state in which the air blower 100 is attached to the duct 101A. Although unnecessary when the air blower 100A of the mist collection section 110 is replaced, a shield sheet metal 131 illustrated in FIG. 2 is detached in advance when the air blower 100B of the paper dust collection section 120 is replaced. Since the shield sheet metal 131 is a member screwed in the X-axis direction, the shield sheet metal 131 can be easily detached by removing screws.

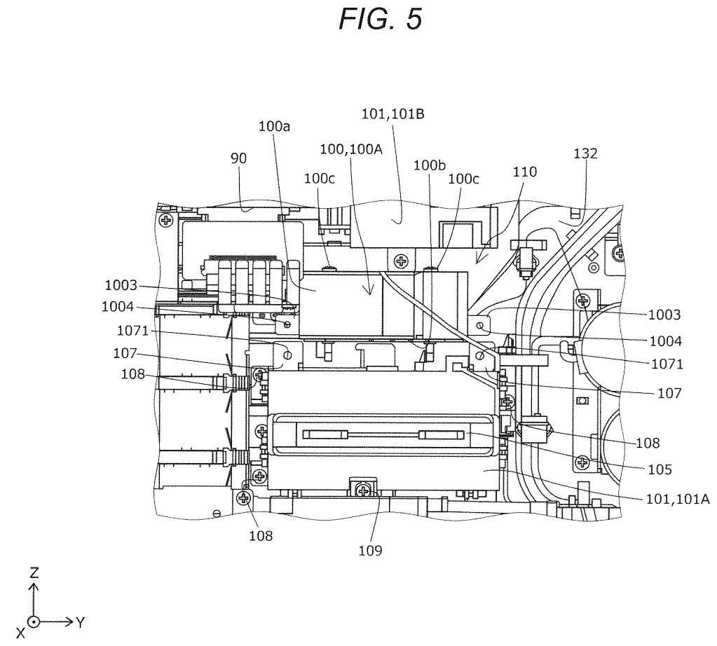

First, the metal screws 106 are detached from the state illustrated in FIG. 4. Then, by moving the air blower 100 in the −X direction on the duct 101A, the fixed sections 1003 are separated from the eaves sections 1072, the protruding section 1001 of the sheet metal 100b is separated from the eaves section 1002, and the air blower 100 becomes movable in the +Z direction. Thereafter, the air blower 100 is moved in the +Z direction from the duct 101A. FIG. 5 illustrates a state in which the air blower 100 is moved in the +Z direction from the duct 101A. Then, the air blower 100 is moved in the +X direction to detach the air blower 100 to the outside of the apparatus.

When a new air blower 100 is attached, the new air blower 100 is brought into the state illustrated in FIG. 5 and is moved in the −Z direction and placed on the duct 101A. At this time, the fixed sections 1003 are located further on the −X direction side than the fixing sections 107. Fine adjustment is performed such that the screw holes 1004 of the fixed sections 1003 and the hole sections 1071 of the fixing sections 107 are aligned when viewed from the X-axis direction, and the metal screws 106 are screwed and tightened. Then, as the metal screws 106 are tightened, the air blower 100 slides on the duct 101A in the +X direction. According to this sliding, the eaves sections 1072 are located at positions facing the fixed sections 1003 from the +Z direction side and the eaves section 1002 is located at a position facing the protruding section 1001 of the sheet metal 100b from the +Z direction side. The metal screws 106 may be tightened after the air blower 100 is slid in the +X direction on the duct 101A. Although unnecessary when the air blower 100A of the mist collection section 110 is replaced, when the air blower 100B of the paper dust collection section 120 is replaced, the shield sheet metal 131 illustrated in FIG. 2 is attached thereafter.

As explained above, the sheet metal 100b serving as the attachment section includes the protruding section 1001 serving as the restricted section that is restricted from moving in the first direction (the Z-axis direction) by the eaves section 1002 serving as the restricting section. The protruding section 1001 is capable of, by sliding the air blower 100 in the direction (the X-axis direction) intersecting the first direction, switching the state of being engaged with the eaves section 1002 and the state of not being engaged with the eaves section 1002. With such a configuration, it is possible to easily implement engagement of the restricting section and the restricted section. In the present embodiment, the air blower 100 is configured to slide in the X-axis direction according to the screwing but may be, for example, configured to slide in the Y-axis direction according to the screwing or the air blower 100 may be configured to slide in the Y-axis direction to be restricted from moving in the +Z direction by the restricting section or limited from moving in the +Z direction by the limiting sections.

As illustrated in FIGS. 3 to 6 and the like, the mist collection section 110 in the present embodiment includes a side surface portion 1012 of the duct 101A serving as the second mounting section on which the filters 105 serving as the capturing section that captures foreign matters such as paper dust and mist can be mounted. Here, the filters 105 are attached to the side surface portion 1012 of the duct 101A in the second direction (the X-axis direction).

With such a configuration, it is possible to capture foreign matters in the duct 101. Since both of the replacement direction of the filters 105 and the access direction to the metal screws 106 are the second direction (the X-axis direction) and can be the same direction, it is possible to easily perform maintenance of the apparatus in one direction and it is possible to reduce a space necessary for the maintenance. However, the replacement direction of the filters 105 may be the Y-axis direction.

Here, from the viewpoint of the airflow generation device, the mist collection section 110 in the present embodiment includes the duct device and the air blower 100. For this reason, the mist collection section 110 in the present embodiment can be the airflow generation device that can facilitate attachment and detachment of the fan 100a while suppressing an increase in the size of the device.

As illustrated in FIGS. 3 to 5, the printer 10 in the present embodiment includes a frame 132. When the frame 132 is considered a constituent member of the airflow generation device, the mist collection section 110 in the present embodiment serving as the airflow generation device can be regarded as including the frame 132 to which the duct device is attached. The duct device is attached to the frame 132 in the second direction (the X-axis direction). With such a configuration, since both of the attachment direction of the duct device and the access direction of the metal screws 106 are the second direction (the X-axis direction) and can be the same direction, it is possible to easily perform maintenance of the device in one direction and it is possible to reduce a space necessary for the maintenance.

Here, as explained above, in the mist collection section 110, the air blower 100 and the upper surface portion 1011 of the duct 101A are fixed by the metal screws 106. On the other hand, the duct 101A is fixed to the frame 132 by metal screws 108 illustrated in FIG. 10 and the like. Further, the duct 101A is fixed to the duct 101B and the duct 101C by metal screws 109 illustrated in FIG. 10 and the like.

As illustrated in FIG. 3 and the like, the printer 10 in the present embodiment includes a housing 13 in which the duct device is housed. Here, the housing 13 is opened upstream in the insertion direction of the metal screws 106 (−X direction) in the second direction (the X-axis direction). That is, the inside of the housing 13 can be opened by opening and closing a not-illustrated door in the +X direction. FIG. 3 and the like illustrate a state in which the not-illustrated door is opened. When the housing 13 is considered a constituent member of the airflow generation device, in the mist collection section 110 in the present embodiment serving as the airflow generation device, with the configuration explained above, the opening provided in the housing 13 is on the upstream side in the insertion direction of the metal screws 106 (the −X direction) and the metal screws 106 and the fan 100a can be easily attached and detached through the opening.

Here, from the viewpoint of the recording apparatus, the printer 10 in the present embodiment includes the recording section 18 (the line head 48) that performs recording on the medium P and the airflow generation device (the mist collection section 110 and the paper dust collection section 120). For this reason, the printer 10 in the present embodiment can be the recording apparatus that can facilitate attachment and detachment of the fan 100a while suppressing an increase in the size of the apparatus.

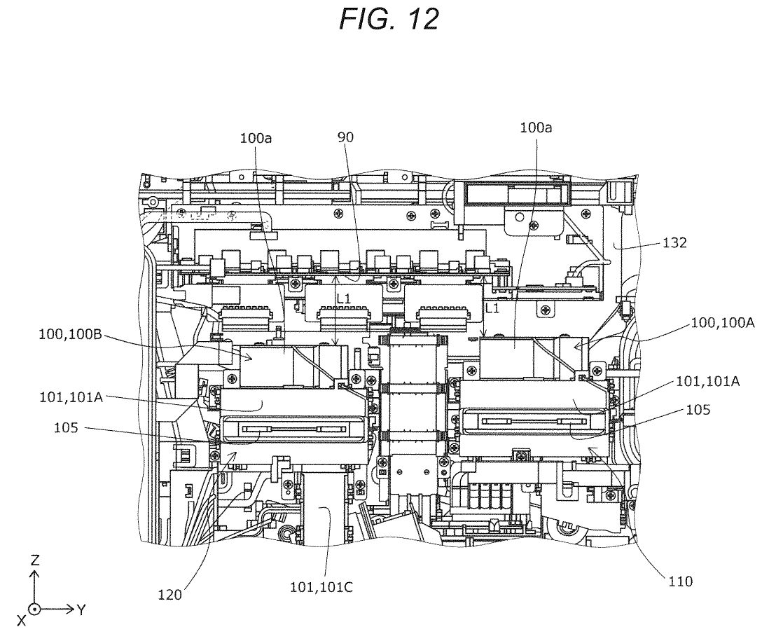

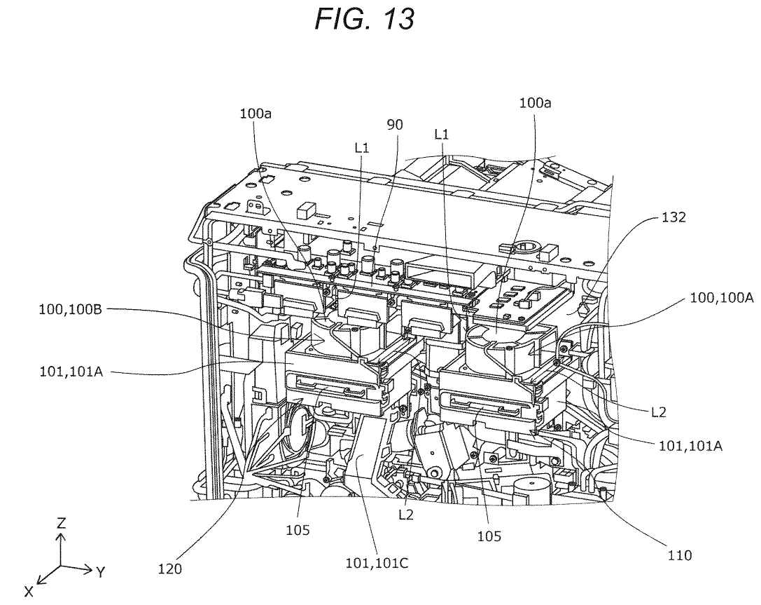

The printer 10 in the present embodiment includes the control section 90 that controls the constituent members of the printer 10 such as the line head 48. Here, the control section 90 in the present embodiment is a control board as illustrated in FIGS. 12 and 13. As illustrated in FIGS. 12 and 13, the control section 90 includes a head drive substrate that controls the line head 48. The printer 10 in the present embodiment is configured such that a distance L1 between the control section 90 and the mist collection section 110 and the paper dust collection section 120 serving as the airflow generation device in the first direction (the Z-axis direction) illustrated in FIGS. 12 and 13 is smaller than a distance L2 between the end portions of the mist collection section 110 and the paper dust collection section 120 serving as the duct device and the fixing sections 107 in the insertion direction of the metal screws 106 (the −X direction) in the second direction (the X-axis direction) illustrated in FIGS. 6 and 13. With such a configuration, the printer 10 in the present embodiment can be easily maintained because the metal screws 106 can be accessed in the second direction (the X-axis direction) even if the control section 90 is configured to block access to the metal screws 106 in the first direction (the Z-axis direction).

The present disclosure is not limited to the embodiment explained above and various modifications can be made within the scope of the disclosure described in the claims, and it goes without saying that the modifications are also included within the scope of the present disclosure.

What is claimed is:

1. A duct device on which an air blower including a fan is mounted and in which gas is circulated by the fan, the duct device comprising:
a first mounting section on which the air blower is mounted to face the first mounting section in a first direction; and
a supporting part to which the air blower is fixed by a fixing member, wherein
the fixing part fixes the air blower and the supporting part in a second direction intersecting the first direction.

2. The duct device according to claim 1, wherein the supporting part is located further downstream than a center of the fan in an insertion direction of the fixing part in the second direction.

3. The duct device according to claim 2, wherein the supporting part is located further downstream than the fan in the insertion direction.

4. The duct device according to claim 1, wherein, in the first direction, the supporting part is located in a range in which the fan is disposed.

5. The duct device according to claim 1, wherein
the air blower includes the fan and an attachment section attached to the supporting part,
the attachment section includes a fixed section fixed to the supporting part, and
the supporting part and the fixed section extend in the first direction.

6. The duct device according to claim 5, wherein
the fixed section is formed of metal, and
the fixing part is screwed into the fixed section.

7. The duct device according to claim 5, wherein the supporting part includes a limiting section configured to limit movement of the fixed section in the first direction.

8. The duct device according to claim 1, wherein
the air blower includes the fan and an attachment section attached to the supporting part, and
the first mounting section includes a restricting section configured to restrict movement of the attachment section in the first direction.

9. The duct device according to claim 8, wherein
the attachment section includes a restricted section restricted from moving in the first direction by the restricting section, and
the restricted section is capable of, by sliding the air blower in a direction intersecting the first direction, switching a state of being engaged with the restricting section and a state of being not engaged with the restricting section.

10. The duct device according to claim 1, further comprising a second mounting section on which a capturing section configured to capture foreign matters can be mounted, wherein
the capturing section is mounted on the second mounting section in the second direction.

11. An airflow generation device comprising:
the duct device according to claim 1; and
the air blower.

12. The airflow generation device according to claim 11, comprising a frame to which the duct device is attached, wherein
the duct device is attached to the frame in the second direction.

13. The airflow generation device according to claim 11, comprising a housing in which the duct device is housed, wherein
the housing is opened upstream in an insertion direction of the fixing part in the second direction.

14. A recording apparatus comprising:
a recording section configured to perform recording on a medium; and
the airflow generation device according to claim 11.

15. The recording apparatus according to claim 14, comprising a control section configured to control the recording section, wherein
a distance between the control section and the airflow generation device in the first direction is smaller than a distance between an end portion of the duct device and the supporting part in an insertion direction of the fixing part in the second direction.
